(19) United States
(12) Patent Application Publication
(10) Pub. No.: US 2004/0060597 A1
(43) Pub. Date: Apr. 1, 2004

(54) Inflating or deflating valve at least to a pre-adjusted pressure

(76) Inventor: Jean-Michel Boulicault, Noailly (FR)

Correspondence Address: Parkhurst & Wendel, Suite 210, 1421 Prince Street, Alexandria, VA, 22314-2805, US

(21) Appl. No.: 10/467,364

(22) PCT Filed: Feb. 4, 2002
(86) PCT No.: PCT/FR02/00407

(30) Foreign Application Priority Data
Feb. 9, 2001 (FR) 01/01766

(51) Int. Cl. F16K 15/20

(52) U.S. Cl. 137/224

(57) ABSTRACT

The invention relates to an inflation or deflation valve 1 to at least a predefined pressure intended to adjust and/or control the pressure of a fluid inside a volume 10, comprising a membrane 4 placed between a first body 2 and a second body 3 connected together by linking means, said membrane delimiting a first chamber 5 with the first body 2 and a second chamber 6 with the second body 3 and pressing, through the action of a spring 18, on a seat delimited by the lower body.

The second body 3 comprises intake piping 8 connecting the second chamber 6 to the volume 10 via a valve 9, said piping 8 opening out on the side of the second chamber 6 by the seat 7, at least one calibrated outlet piping being made in the second body so as to make the second chamber 6 communicate with the outside environment to constitute pneumatic means to adjust said predefined pressure.

Application to vehicles.

The technical scope of the present invention is that of devices to adjust and control a pressure within a volume and more particularly relates to the inflation and deflation of the pneumatic tyre of a wheel of a vehicle.

In the preferred domain of application above, we know that several means exist to adjust or control the pressure of a pneumatic tyre. This is essential to be able to adapt this pressure to the characteristics of the ground to be driven over. This becomes more than apparent when driving over normal road, followed by a stretch of motorway and similarly when driving an empty or fully loaded vehicle. It is therefore necessary to know at least two pressure values, which are fortunately often indicated on the vehicle body. However, the problem becomes more complicated for all-purpose vehicles that requires different adjustments on each wheel of the same axle and this over four types of ground. By way of illustration, for an all-purpose double-axled vehicle fitted with four wheels per axle, sixteen different pressure values need to be known. These pressure changes highlight certain constraints, notably those of knowing the different pressures and naturally of possessing particular apparatus such as a tyre pump equipped with a manometer of which the condition and reading accuracy is often unknown.

This application is obviously only given by way of example, since, in many other domains, it is also useful, if not essential, to be able to adjust or control the inflation pressure of any volume and this in an extremely simple manner.

To overcome the problem above, prior art offers few solutions. Thus, patent FR-A-1563179 describes a sort of valve able to initiate inflation and deflation but which is impossible to adjust simply, has an extremely complex control circuit and is not removable.

Patent FR-A-2598771 describes a remotely-controlled pneumatic valve constituted by two inflation and deflation bodies delimiting two cavities, respectively the admission and exhaust cavities. These two cavities communicate between each other by an intercommunication that forms two seats in the chambers for two servo-valves and which is linked, between the seats, to piping leading to a connecting chamber at a control installation; the exhaust chamber however is in relation with the ambient environment via exhaust holes into the open air.

Such a valve is not satisfactory in that is has to be mounted permanently. Additionally, it functions in a particularly complicated manner therefore increasing the cost.

There are naturally other remotely-controlled inflation systems that are unremovably mounted on vehicles whether they are in movement or not, such as described in patents EP-0246953, U.S. Pat. No. 2,633,889, DE-3246601, U.S. Pat. No. 180456 or U.S. Pat. No. 5,263,524. These systems are complex and naturally expensive and they can therefore not be installed on all vehicles and not in particular on small or medium range vehicles.

The aim of the invention is to propose simple, rapid and inexpensive means that overcome the above-mentioned drawbacks. Thus, the inflation and deflation valve according to the invention has the unequivocal advantages of being easy to implement and being able to be installed permanently or temporarily.

The invention thus relates to an inflation or deflation valve to at least a predefined pressure intended to adjust and/or control the pressure of a fluid inside a volume, comprising a membrane placed between a first body and a second body connected together by linking means, said membrane delimiting a first chamber with the first body and a second chamber with the second body and pressing, through the action of a spring, on a seat delimited by the lower body, wherein the lower body comprises intake piping connecting the second chamber to the volume via a valve, said piping opening out on the side of the second chamber by the seat, at least one calibrated outlet piping being made in the lower body so as to make the second chamber communicate with the outside environment to constitute pneumatic means to adjust said predefined pressure.

According to one characteristic of the invention, the spring is calibrated so as to exert a predetermined force on the membrane according to the predefined pressure.

According to an advantageous embodiment of the invention, the pneumatic adjustment means are constituted by the pressure in the second chamber.

According to yet another characteristic of the invention, the second body comprises at least two calibrated outlet pipings and selection means to make said piping communicate with the external environment.

Advantageously, each of the pre-adjusted pressures is conditioned by a particular restriction.

Advantageously again, the pre-adjusted pressure selection means comprise a revolving stopper provided with a first slot to make one outlet piping communicate with the external environment, the other outlet piping being blanked out by the stopper.

According to yet another characteristic of the invention, the selection means are provided with a second slot that reveals an indication on the pre-adjusted pressure value.

According to yet another characteristic of the invention, the revolving stopper has a handle to ensure its manual rotation.

According to yet another characteristic of the invention, deflation is caused by moving away the seat membrane.

Advantageously, the membrane is moved away through the pressurising of the second chamber by means of an external pneumatic source.

Advantageously again, the membrane is moved away through the compression of the spring by means of a slide, one end of which is accessible.

Advantageously again, the piping is connected to the valve of the volume in a removable manner.

A first advantage of the inflation and deflation valve according to the invention lies in its easy implementation.

Another advantage of the invention lies in that it may be removed and thus constitutes an accessory of the vehicle.

Another advantage lies in the fact that the valve can be adjusted according to the pressure required for the drive being carried out.

Another advantage of the valve according to the invention lies in the fact that all pneumatic sources may be used thereby obviating the need for classical pump devices.

Other characteristics, particulars and advantages of the invention will become more apparent from the following description given by way of illustration and in reference to the drawings, in which:

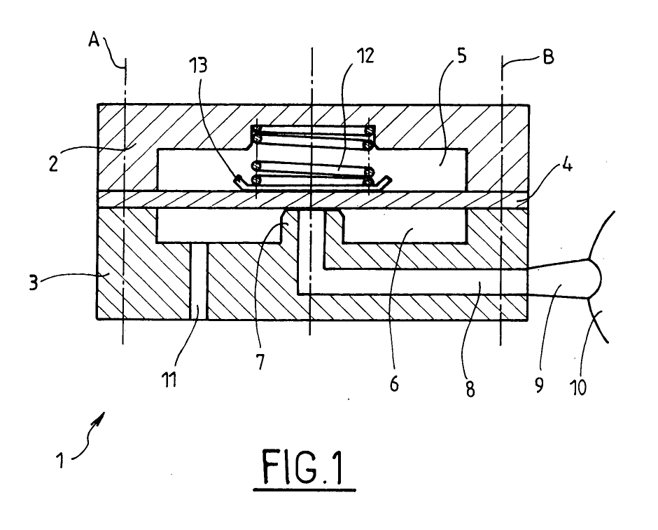

FIG. 1 is a section view of the valve in accordance with the invention according to a first embodiment,

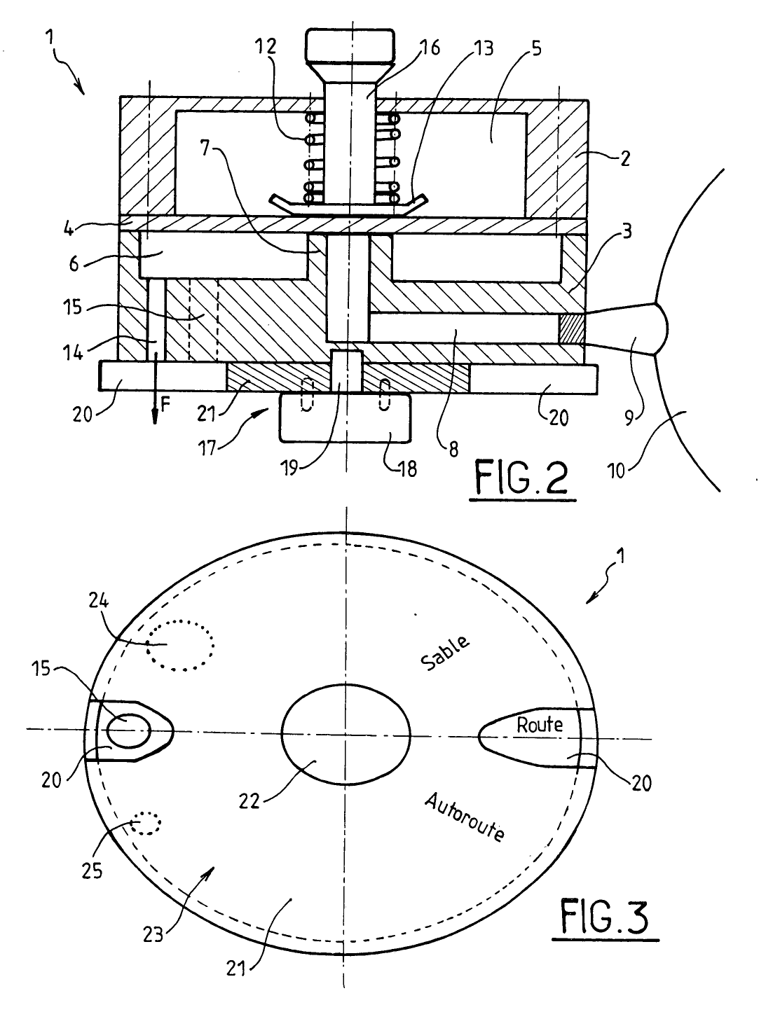

FIG. 2 is a cross section of the valve in accordance with the invention according to a second embodiment, and

FIG. 3 is a bottom view of the valve in accordance with the invention shown in FIG. 1.

The inflation and deflation valve 1, shown in FIG. 1, is constituted by a first body 2 and a second body 3 between which a membrane 4 is positioned. The two bodies 2 and 3 are machined to delimit with the membrane 4 respectively a first chamber 5 and a second chamber 6. These two bodies 2 and 3, made of any suitable material, are connected together face to face around their peripheries thereby hermetically sealing the contours of the membrane 4. This assembly is ensured by linking means following the two vertical dotted lines A and B that can be, for example, screws, rivets or any form of interlocking. The second body 3 has, inside the second chamber, a seat 7 on which the membrane 4 presses. A piping 8 is made in the body 3, one of its ends opening out into the second chamber 6 passing through the seat 7 and the other end being connected to a valve 9 of a known type generally mounted on the wheel rim of a vehicle (not shown). The connection between the valve 1 and the valve 9 may be made by a threaded, clipped or other hermetic system. Naturally, this link may be of the fixed type for permanent mounting of the valve 1 or of the removable type for occasional adjustments and/or controls. In this case, the valve 1 constitutes an accessory to the vehicle and may be stored, for example, in the glove compartment.

The valve 9 is connected to a volume 10 which in the embodiment described is, for example, a pneumatic tyre. The body 3 has at least one calibrated piping 11 that may advantageously be dimensioned by its diameter or its length or both to ensure the pressurisation of the chamber 6 as will be explained after. This piping 11 makes the inside of the second chamber 6 communicate with the external environment.

A spring 12 is placed in the first chamber 5, one of its ends being in contact with the bottom of the body 3 whereas the other presses on the membrane 4 by means of a washer 13. The invention is limited to this embodiment if the valve is intended to offer a single pre-adjusted pressure.

According to the embodiment shown in FIG. 2, the second body 2 incorporates as many restrictions as pressures to be pre-adjusted imposed by the manufacturer of the vehicle for the correct use of the pneumatic tyre. In the embodiment shown in this Figure, the second body 3 comprises two piping 14 and 15 one of which can not be seen in the section view of the valve 1 shown.

To obtain the two pre-adjusted pressures, a slide 16 is provided in the body 2. Said slide is slipped into the twisted spring 12. This slide 16 is integral at one of its ends with the washer 13 whereas the other end protrudes from the body 2, and it is shaped to make it easier for a user to handle, for example thanks to a knurled end. This slide 16 may, depending on the case, be installed beside the body 3 passing through the piping 8 and coming to press on the membrane 4. These two arrangements of the slide 16 fulfil the same function, that is the deflation of the vehicle wheel. However, this function may also be obtained without using the slide 16 by means of another embodiment which will be described later.

A selection means 17 comprise a revolving stopper 18 connected to the lower body 2 by a hinge pin 19, the assembly being substantially sealed. This revolving stopper 18 has two slots 20 and 21 whose embodiment will be detailed in the description that follows related to FIG. 3. The stopper 18 is made to revolve thanks to a handle 22 activated manually by the user and illustrated in FIG. 3.

FIG. 3 shows a bottom view of the general shape of the valve 1. The selection means 23 may be observed in particular, said means being constituted by the revolving stopper 18 and the handle 22. The role of the revolving stopper 18 is more apparent from this Figure. As described previously, it has two slots 20 and 21. One of them reveals an indication of the type of ground the user is driving over or intends to drive over. The other slot releases piping, 14 for example, in relation to the indication revealed by the first slot. The indications are inscribed by any means on the face of the body 3. We notice in the embodiment in this Figure that only the “ROAD” indication appears whereas the other indications “MOTORWAY” and “SAND” are hidden, piping 24 and 25 corresponding to these invisible indications are blanked out by the revolving stopper 18. Naturally, these indications are given merely by way of illustration and may vary depending on the vehicle in question. We also note the difference in diameter of the piping. The smaller the piping, the higher the pressure under the membrane and the longer the deflation time.

The valve 1 inventively comprises pneumatic adjustment means with a view to reaching a pre-adjusted pressure. These adjustment means are mainly constituted by means to fix the pre-adjusted pressure, the pressure selection means 17 and means to signal the pressure reached, these being constituted by the pressurised air flow following arrow F. The creation of the pre-adjusted pressure fixing means is based on a pneumatic principle. The pressure of the fluid contained in the chamber 6 (coming from the tyre 10) exerts a so-called regulating force on the membrane 4. This regulating force is countered by the force exerted by the spring 12 on the membrane 4. The regulating force is conditioned by the characteristics of the outlet piping 14, 24 or 25 updated by the revolving stopper 18. Indeed, the evacuation of the pressure in the chamber 6 is reduced by the channelling. Consequently, the regulating force is greater than the force exerted by the spring 12, thereby releasing the seat 7 and evacuating the excess pressure in the volume 10. Depending on the piping selected, a balance will appear between the forces after a variable length of time. This time difference will cause the volume 10 to be brought to the required pre-adjusted pressure.

The operation and use of the valve 1 according to the invention is as follows.

In the starting position when fixed upon the valve 9, the valve 1 prevents any fluid from exiting the volume 10 since the spring 12 exerts a force on the membrane 4 thereby preventing the circulation of fluid between the piping 8 and the chamber 6.

During the inflation operation, the user does not know the pressure or pressures recommended for the vehicle. The valve 1 allows the fluid through into the volume 10. To do this, the connection of a pneumatic source (for example a portable air gun) onto one of the outlet piping lifts the membrane 4 from the seat 7 and allows the fluid to enter the volume 10 via the piping 8 and the valve 9. This operation is carried out for a certain time. The application of the pneumatic source is not necessarily hermetic.

When the source is removed, two cases are possible, the first of which illustrates the indication means of the pressure reached:

If the pressure injected in the volume 10 is too great, the pressure value corresponding to that pre-adjusted by the selection means 17 has been exceeded. The membrane 4 is not able to immediately block the seat 7. The circulation of fluid will thus reverse, that is it will travel from the volume 10 to the chamber 6 and then out to the external environment through the piping, which is selected according to the pressure required. When the pre-adjusted pressure conditioned by this piping has been reached, the pressure in the chamber 6 will not be enough to create the regulating force required to compress the spring 12 and keep the membrane 4 lifted. Said membrane 4 will therefore block the seat 7 and stop the fluid circulation. This process constitutes an evacuation of fluid followed by its interruption. The pre-adjusted pressure is sure to be reached and, by means of this process, the user is informed of this. The valve 1 has therefore automatically adjusted the pressure.

If the pressure injected in the volume 10 is insufficient, the pressure value corresponding to that pre-adjusted by the selection means 17 has not been reached. The membrane 4 will immediately block the seat 7. In this case, the user has not detected the indication means by the evacuation of fluid and understands that the pre-adjusted pressure has not been reached. The inflation operation must be carried out as often as necessary to detect the ejection of pressurised fluid following arrow F.

During the deflation operation, the pre-adjusted pressure may be reached in one of two ways.

The first does not require a slide 16. It consists in applying the rudimentary pneumatic source to the piping for a very short time. The membrane 4 will in this case be lifted and, as described previously, will block the seat 7 only when the volume 10 has reached the pre-adjusted pressure.

The second manner of deflation consists in releasing the membrane 4 from the force exerted by the spring 18 for a very short time. This may be carried out by compressing the spring 12 by pulling the slide 16 connected to the washer 13. The pressure in the volume 10 in this case lifts the membrane 4 from the seat 7 and, as described previously, will only block the seat when the pre-adjusted pressure has been reached. The slide may also be installed on the opposite side (not shown) of the membrane which it will push thereby allowing the fluid to circulate from the volume 10 towards the chamber 6. Different possibilities may be used to allow the arrival of fluid in the chamber 6 without departing from the scope of the invention.

By way of illustration, a user of an all-purpose vehicle that is fitted with a valve according to the invention having four pre-adjusted pressures mounted integral with each wheel, drives from a road surface to a sand surface. The user does not know the pressure recommended for this type of ground. The valves 1 are not equipped with a slide 16 for deflation. However, there is a small, inexpensive, pressurised gas container of the manual aerosol type. The user positions the selection means 17 on “Sand” and applies the pressurised gas container to the only accessible piping for approximately one second. As soon as he has detected the indication means following arrow F, the user can move on to the next wheels. For a six-wheeled vehicle, for example, the user will only have to leave the vehicle for thirty seconds or so. The deflation times are considerably reduced as the required pressures are automatically adapted.

1. An inflation or deflation valve (1) to at least a predefined pressure intended to adjust and/or control the pressure of a fluid inside a volume (10), comprising a membrane (4) placed between a first body (2) and a second body (3) connected together by linking means, said membrane delimiting a first chamber (5) with the first body (2) and a second chamber (6) with the second body (3) and pressing, through the action of a spring (18), on a seat delimited by the lower body, wherein the second body (3) comprises intake piping (8) connecting the second chamber (6) to the volume (10) via a valve (9), said piping (8) opening out on the side of the second chamber (6) by the seat (7), at least one calibrated outlet piping being made in the second body so as to make the second chamber (6) communicate with the outside environment to constitute pneumatic means to adjust said predefined pressure.

2. An inflation or deflation valve (1) according to claim 1, wherein the spring (18) is calibrated so as to exert a predetermined force on the membrane (4) according to the predefined pressure.

3. An inflation or deflation valve according to claim 2, wherein the pneumatic adjustment means are constituted by the pressure in the second chamber (6).

4. An inflation or deflation valve (1) according to claim 3, wherein the second body (3) comprises at least two calibrated outlet piping (14, 15) and selection means (17) to make said piping communicate with the external environment.

5. An inflation or deflation valve (1) according to claim 4, wherein the pre-adjusted pressure selection means (17) comprise a revolving stopper (18) provided with a first slot (20) to make one outlet piping communicate with the external environment, the other outlet piping being blanked out by the stopper.

6. An inflation or deflation valve (1) according to claims 4 or 5, wherein the selection means (17) are provided with a second slot (21) in order to reveal an indication on the pre-adjusted pressure value.

7. An inflation or deflation valve (1) according to claim 6, wherein the revolving stopper (18) has a handle (22) to ensure its manual rotation.

8. An inflation or deflation valve (1) according to any one of the above claims, wherein deflation is caused by the lifting of the membrane (4) from the seat (7).

9. An inflation or deflation valve (1) according to claim 8, wherein the membrane (4) is lifted by means of the pressurising of the second chamber using an external pneumatic source.

10. An inflation or deflation valve (1) according to claim 9, wherein the membrane (4) is lifted by compressing the spring (12) by means of a slide (16) one end of which is accessible to the exterior.

11. An inflation or deflation valve (1) according to any one of the above claims, wherein the piping (8) is linked to the valve (9) of the volume (10) in a removable manner.
